(19) United States
(12) Patent Application Publication
(10) Pub. No.: US 2010/0076655 A1
(43) Pub. Date: Mar. 25, 2010

(54) INPUT TORQUE LIMITING CLUTCH FOR POWER TRANSFER ASSEMBLY

(75) Inventors: James S. Brissenden, Baldwinsville, NY (US); Richard Bakowski, Warners, NY (US)

Correspondence Address: HARNESS, DICKEY & PIERCE, P.L.C., P.O. BOX 828, BLOOMFIELD HILLS, MI, 48303, US

(73) Assignee: MAGNA POWERTRAIN USA, INC., Troy, MI (US)

(21) Appl. No.: 12/517,003

(22) PCT Filed: Nov. 8, 2007
(86) PCT No.: PCT/US07/23520

§ 371 Date: May 29, 2009

Related U.S. Application Data
(60) Provisional application No. 60/872,068, filed on Nov. 30, 2006.

(51) Int. Cl. G06F 17/00; F16D 11/04; F16D 43/20

(52) U.S. Cl. 701/67; 192/66.31; 192/55.1

(57) ABSTRACT

A vehicle driveline component that includes an input member, at least one output member and a preloaded clutch that is disposed between the input member and the at least one output member. The preloaded clutch limits drive torque transmitted form the input member to each output member. The driveline component is selected from a group consisting of transfer cases, propshafts, viscous couplings and differentials. A related method is also provided.

### INTRODUCTION

The present disclosure generally relates to vehicle drivelines and more particularly to a power transfer assembly in a vehicle driveline having a pre-loaded input clutch for limiting the transmission of drive torque through the power transfer assembly.

The drive torque provided through a vehicle drive line can vary widely based upon various vehicle and road conditions. In a conventional vehicle drive line, it is possible for the drive line to experience peaks in the transmission of drive torque that exceed two or three times the vehicle skid torque (also known as the vehicle slip torque). As will be appreciated, the use of components that are designed to handle two or three times the vehicle skid torque is disadvantageous in that these components (and therefore the vehicle) tend be more costly and heavy. Given that a vehicle's fuel economy is related to its weight, the weight of the vehicle drive line can be of particular significance.

### SUMMARY

In one form, the present teachings provide a method that includes: determining a vehicle skid torque; determining a threshold torque that is greater than or equal to the vehicle skid torque but lower than a predetermined peak torque; and coupling a clutch to an input member of a power transfer assembly, the clutch being operable for limiting torque transmission to each of a plurality of components receiving rotary power from the power transfer assembly, the plurality of components being configured to transmit rotary power to at least one set of driven wheels; wherein the clutch is preloaded such that a magnitude of drive torque at the at least one set of driven wheels does not exceed the threshold torque.

In another form, the present teachings provide a vehicle driveline component that includes an input member, at least one output member and a preloaded clutch that is disposed between the input member and the at least one output member. The preloaded clutch limits drive torque transmitted form the input member to each output member. The driveline component is selected from a group consisting of transfer cases, propshafts, viscous couplings and differentials.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of a vehicle having an exemplary power transfer assembly constructed in accordance with the teachings of the present disclosure;

FIG. 2 is a sectional view of a portion of the vehicle of FIG. 1 illustrating the power transfer assembly in greater detail; and

FIGS. 3, 4 and 5 are schematic illustrations similar to that of FIG. 1 but illustrating vehicles having other types of power transfer assemblies constructed in accordance with the teachings of the present disclosure.

### DETAILED DESCRIPTION OF THE VARIOUS EMBODIMENTS

Referring now to the drawings, an exemplary vehicle 10 is schematically shown to include a front driveline 12 and a rear driveline 14 that are drivable from a power train. The power train can include an engine 16 and transmission 18, which may be of either the manual or automatic shifting-type. In the particular example illustrated, the vehicle 10 further includes a transfer case 20 for transmitting drive torque from the transmission 18 to the front and rear drivelines 12 and 14. The front driveline 12 includes a pair of front wheels 22 that are connected to opposite ends of a front axle assembly 24. The front axle assembly 24 can include a front differential 26 that can be coupled one end of a front drive shaft 28. The end of the front drive shaft 28 opposite the front differential 26 can be coupled to a front output shaft 30 of the transfer case 20. Similarly, the rear driveline 14 can include a pair of rear wheels 32 that can be connected to the opposite ends of a rear axle assembly 34. The rear axle assembly 34 can have a rear differential 36 that can be coupled to an end of a rear drive shaft 38. The end of the rear drive shaft 38 opposite the rear differential 36 can be coupled to a rear output shaft 40 of the transfer case 20.

In the particular example provided, the transfer case 20 can be generally similar to that which is described in U.S. Pat. No. 6,709,357, the disclosure of which is hereby incorporated by reference as if fully set forth in detail herein. Those of ordinary skill in the art will appreciate, however, that the transfer case 20 could be generally similar to other types of transfer cases, such as those that are described in U.S. Pat. Nos. 6,712,729, 6,719,656, 6,824,487, and 6,846,262, the disclosures of which are hereby incorporated by reference as if fully set forth in detail herein.

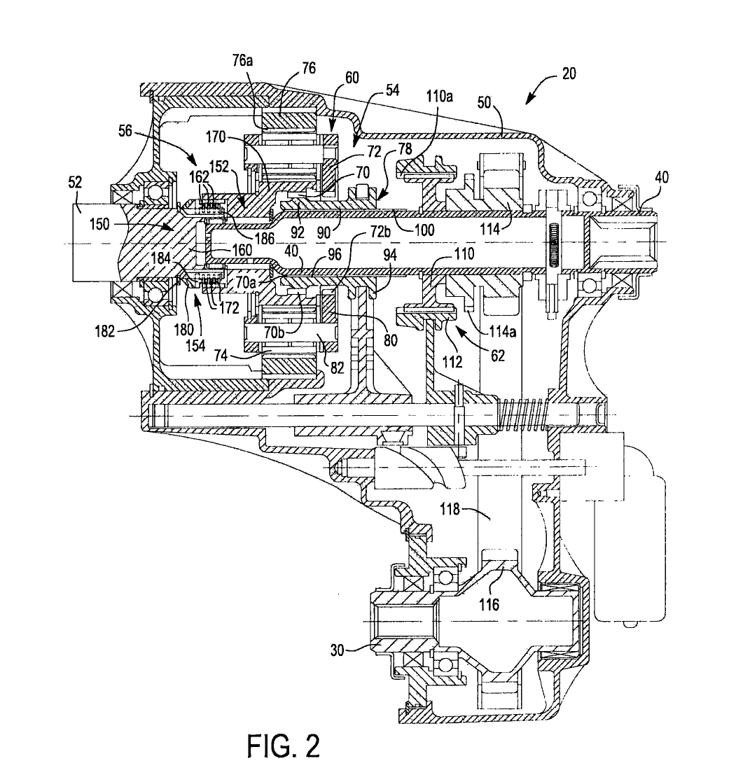

With additional reference to FIG. 2, the transfer case 20 can include a housing 50, an input shaft 52, a power distributing system 54 and an input clutch 56. The input shaft 52 is supported for rotation by the housing 50 and is coupled to an output member (not shown) of the transmission 18 to receive drive torque therefrom. The power distributing system 54 is employed to distribute drive torque received from the input shaft 52 to the front and rear output shafts 30 and 40 in a desired manner. Typically, the manner in which drive torque is distributed between the front and rear output shafts 30 and 40 is dependent upon the configuration of the particular power distributing system that is employed, and the mode in which the transfer case 20 is operated if the transfer case 20 can be operated in more than one mode. In its simplest form, the power distributing system 54 could be configured to split torque in a predetermined manner between the front and rear drivelines 12 and 14 on a full-time basis with no inter-driveline torque differentiation. More sophisticated power distributing systems can permit the drive torque to be selectively applied to one of the drivelines (e.g., the front driveline 12) and can include clutch packs and/or differentials for controlling the distribution of drive torque between the front and rear drivelines 12 and 14. In the particular example provided, the power distributing system 54 includes a two-speed gear train 60, which permits the transfer case 20 to be operated in a high range mode and a low range mode, and a mode clutch 62 that permits the transfer case to be operated in a rear-wheel drive mode and a four-wheel drive mode.

With specific reference to FIG. 2, the two-speed gear train 60 can include a sun gear 70, a planet carrier 72, a plurality of planet gears 74, a ring gear 76 and a range clutch 78. The sun gear 70 can include an outer set of teeth 70a, an inner set of teeth 70b. The planet carrier 72 can include a body 80 and a plurality of pins 82 that can be fixedly (non-rotatably) coupled to the body 80. The body 80 can have an annular shape with a plurality of gear teeth 72b formed at its radially inner edge. The pins 82 can journally support the planet gears 74 for rotation thereon. The planet gears 74 can be meshingly engaged with the outer set of teeth 70a of the sun gear 70 and the teeth 76a of the ring gear 76. The ring gear 76 can be fixedly coupled to the housing 50.

The range clutch 78 can have a tubular body 90 that can define a set of range teeth 92, a yoke 94 and an internally-splined aperture 96. The rear output shaft 40 can include a splined portion 100 that can be non-rotatably but axially slidably received in the internally-splined aperture 96 to thereby non-rotatably couple the rear output shaft 40 and the range clutch 78. The set of range teeth 92 are sized to meshingly engage the inner set of teeth 70b of the sun gear 70 and the teeth 72b that are formed on the body 80 of the planet carrier 72. The range clutch 78 is axially movable on the rear output shaft 40 between a first position, in which the set of range teeth 92 are meshingly engaged to the inner set of teeth 70b of the sun gear 70, and a second position in which the set of range teeth 92 are meshingly engaged to the teeth 72b on the body 80 of the planet carrier 72.

The mode clutch 62 can include a hub member 110, a mode sleeve 112, a drive sprocket 114, a driven sprocket 116 and a chain carrier 118. The hub member 110 can be splined to the rear output shaft 40 to inhibit relative rotation therebetween. The mode sleeve 112 can include a plurality of internal spline teeth 110a that non-rotatably but axially slidably couple the mode sleeve 112 to the hub member 110. The drive sprocket 114 can be rotatably disposed on the output shaft 40 and can include external spline teeth 114a. The driven sprocket 116 can be non-rotatably coupled to the front output shaft 30. The chain carrier 118 can engage the drive sprocket 114 and the driven sprocket 116 to facilitate the transmission of drive torque there between. The mode sleeve 112 is movable between a first position, in which the internal spline teeth 110a are disengaged from the external spline teeth 114a of the drive sprocket 114, and a second position in which the internal spline teeth 110a are engaged to the external spline teeth 114a of the drive sprocket 114. In the former mode of operation, rotary power is not transmitted from the rear output shaft 40 to the drive sprocket 114 and as such, the transfer case 20 is operated in a two-wheel drive mode. In the latter mode of operation, rotary power is transmitted from the rear output shaft 40 to the drive sprocket 114 (and as such, to the driven sprocket 116) so that the transfer case 20 is operated in a four-wheel drive mode.

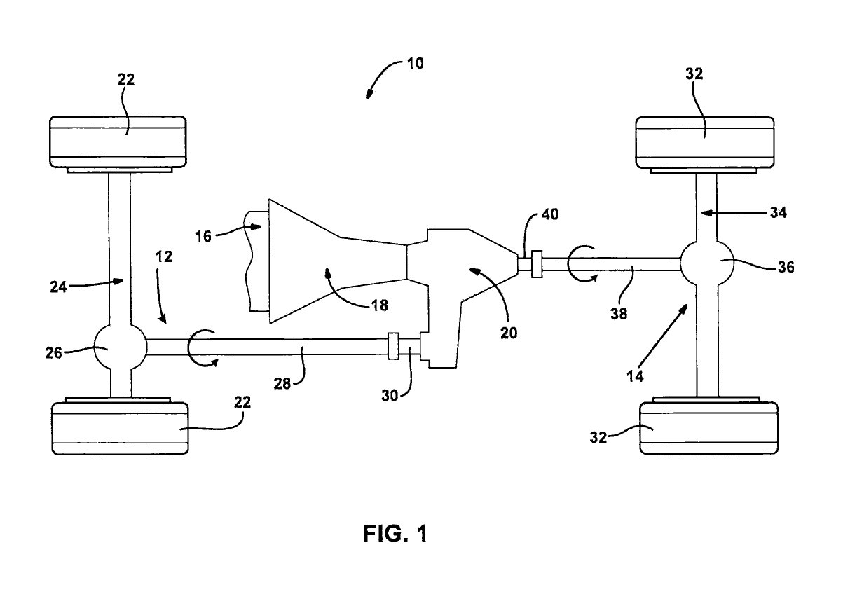

The input clutch 56 can be employed to selectively decouple the sun gear 70 from the input shaft 52. In the particular example provided, the input clutch includes a first clutch portion 150, a second clutch portion 152 and preloading means 154 for preloading the input clutch 56. The first clutch portion 150 can include a first body 160, which is coupled for rotation with the input shaft 52, and a plurality of first clutch plates 162 that are non-rotatably but axially slidably coupled to the first body 160. The second clutch portion 152 can similarly include a second body 170, which can be non-rotatably but axially slidably coupled to the sun gear 70, and a plurality of second clutch plates 172. The preloading means 154 can include any means for loading the input clutch 56 such that the first and second clutch plates 170 and 172 engage one another to permit a predetermined amount of drive torque to be transmitted through the input clutch 56. In the example provided, the preloading means 154 includes a Belleville spring washer 180, a first snap ring 182, a spacer 184 and a second snap ring 186. The predetermined amount of drive torque can correspond to a predetermined threshold torque (i.e., the input clutch 56 will slip when the torque at the vehicle wheels 22 and 32 (FIG. 1) exceeds the predetermined threshold torque). The threshold torque can be greater than or equal to the vehicle skid torque but less than a predetermined peak torque. The Belleville spring washer 180 can be compressed and thereby exert a spring force that drives the first clutch plates 162 into frictional engagement with the second clutch plates 172. The first snap ring 182 can be employed to axially secure the Belleville spring washer 180 to the input shaft 52 to thereby maintain the Belleville spring washer 180 in a compressed state. The second snap ring 186 can be coupled to the first body 160 or the second body 170 as appropriate to limit movement of the first and second clutch plates 162 and 172 in a direction away from the Belleville spring washer 180. The spacer 184 is optional and can have a thickness that is selected to cause the Belleville spring washer 180 to exert a desired preload force. Those of ordinary skill in the art will appreciate that various other arrangements could be employed to preload the input clutch 56, including threaded connections and other types of springs. Those of ordinary skill in the art will also appreciate in view of this disclosure that the input clutch 56 can be configured in any manner that limits the transmission of drive torque between the input shaft 52 of the transfer case 20 and an input member of the power distributing system 54. In this regard, it will be appreciated that the input clutch 56 need not be configured to physically interrupt the transfer of rotary motion between two components (e.g., the input shaft 52 and the sun gear 70) but rather can couple or de-couple various other portions of the power distributing system 54 such that torque in excess of a predetermined threshold torque is not transmitted through the power distributing system 54.

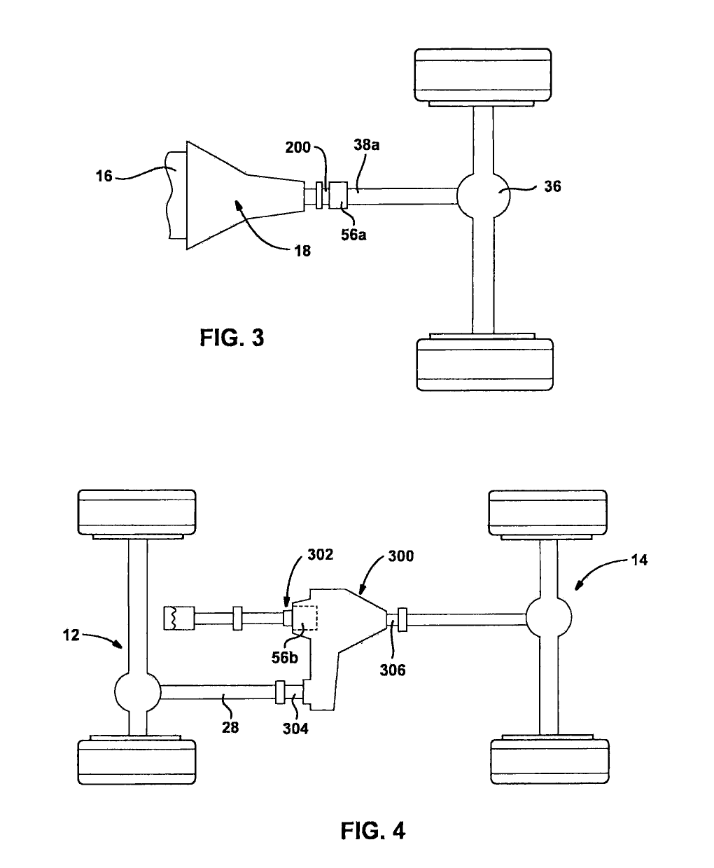

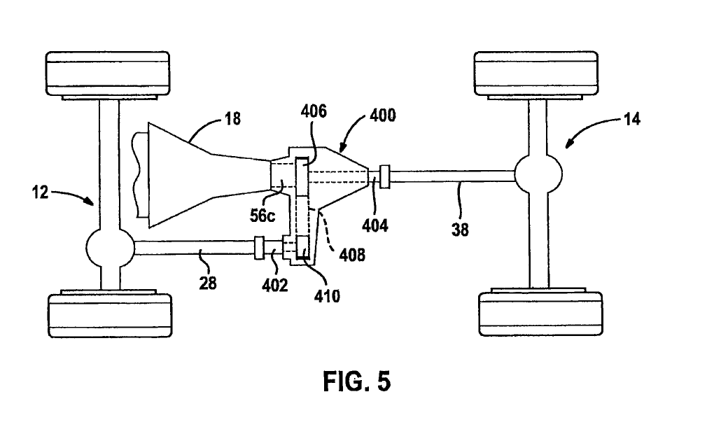

While the vehicle 10 has been illustrated as including a transfer case 20 having an input clutch 56, those skilled in the art will appreciate that the invention, in its broader aspects, may be constructed somewhat differently. For example, it will be appreciated that the input clutch could be associated with any power transfer assembly for a vehicle driveline, including propshafts, viscous couplings and differentials. In the example of FIG. 3, the input clutch 56a is coupled to an input portion 200 of the propshaft 38a. As such, the torque that is transmitted to through the propshaft 38a and input to the rear axle assembly 38 does not exceed the predetermined threshold torque. In the example of FIG. 4, rotary power is received by a center differential 300 from the transmission 18. The input clutch 56b is coupled to the input member 302 of the center differential 300 and limits the torque that is transmitted to the front and rear output shafts 304 and 306 of the center differential 300, as well as to the front and rear drivelines 12 and 14. In the example of FIG. 5, a transfer case 400 is in receipt of power provided from the transmission 18. An input clutch 56c is driven by an output member (not shown) of transmission 18. Transfer case 400 may be arranged as a single speed power splitting device providing a predetermined output percentage of torque to a front output shaft 402 and a rear output shaft 404, as well as to the front and rear drivelines 12 and 14. In particular, a drive sprocket 406 is driven by clutch 56c. A chain 408 drivingly interconnects drive sprocket 406 with a driven sprocket 410. Second output shaft 404 is driven by drive sprocket 406 to provide rotary power to rear driveline 14. First output shaft 402 is driven by driven sprocket 410 to provide rotary power to front driveline 12. Due to the presence of torque limiting clutch 56c and the single speed power splitting device, transfer case 400 may be relatively compact and lightweight.

In view of the above disclosure, it will be appreciated that the input clutch (56, 56a, 56b) can be employed to limit the torque that is transmitted to components of the driveline or drivelines downstream from input clutch and as such, the input clutch can facilitate not only a reduction in the scale or strength of portions of a given power transfer assembly, but also of various components any other power transfer assembly or assemblies that receive rotary power from the power transfer assembly.

While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this invention, but that the scope of the present disclosure will include any embodiments falling within the foregoing description and the appended claims.

What is claimed is:

1. A method comprising:
determining a vehicle skid torque;
determining a threshold torque that is greater than or equal to the vehicle skid torque but lower than a predetermined peak torque; and
coupling a clutch to an input member of a power transfer assembly, the clutch being operable for limiting torque transmission to each of a plurality of components receiving rotary power from the power transfer assembly, the plurality of components being configured to transmit rotary power to at least one set of driven wheels;
wherein the clutch is preloaded such that a magnitude of drive torque at the at least one set of driven wheels does not exceed the threshold torque.

2. The method of claim 1, wherein the power transfer assembly is selected from a group consisting of transfer cases, viscous couplings, propshafts and differentials.

3. The method of claim 1, wherein the clutch includes two sets of interleaved clutch plates.

4. The method of claim 3, further comprising compressing a Belleville spring washer to frictionally engage the two sets of interleaved clutch plates to one another.

5. The method of claim 1, further comprising sizing at least a portion of the plurality of components based on the threshold torque.

6. The method of claim 1, further including a gear set rotatably supported within the power transfer assembly configured to transmit rotary power to a second set of driven wheels.

7. The method of claim 6 wherein the gear set is sized to transfer a magnitude of torque substantially equivalent to a maximum magnitude of torque transferable by the clutch.

8. The method of claim 7 wherein the gear set is a planetary gear set and the input member is a sun gear.

9. A vehicle driveline component comprising:
an input member;
at least one output member, and
a preloaded clutch disposed between the input member and the at least one output member, the preloaded clutch being operable for limiting drive torque transmitted from the input member to each output member;
wherein the driveline component is selected from a group consisting of transfer cases, propshafts, viscous couplings and differentials.

10. The vehicle driveline component of claim 9, wherein the preloaded clutch includes two sets of interleaved clutch plates.

11. The vehicle driveline component of claim 10, wherein a Belleville spring washer preloads the two sets of interleaved clutch plates into frictional engagement with one another.

12. The vehicle driveline component of claim 9, wherein the clutch is operable to transfer a maximum magnitude of torque based on a threshold torque being equal to or greater than a vehicle skid torque but less than a predetermined peak torque.

13. The vehicle driveline component of claim 9 further including a planetary gear set driven by the clutch.

14. The vehicle driveline component of claim 13 wherein the clutch drives a sun gear of the planetary gear set.

15. The vehicle driveline component of claim 9 further including a mode clutch operable in a first position to transfer rotary power from the clutch to the at least one output member and in a second position to transfer rotary power to the at least one output shaft and another output shaft.

16. The vehicle driveline component of claim 9 further including a power splitting mechanism driven by the clutch and providing rotary power to the at least one output shaft and another output shaft.

17. A vehicle driveline component comprising:
a rotary input member;
a rotary output member;
a torque limiting clutch transferring up to a predetermined drive torque between the input member and the output member, wherein the predetermined drive torque is based on a predetermined threshold torque being greater than or equal to a vehicle skid torque but less than a predetermined peak torque.

18. The vehicle driveline component of claim 17 wherein the clutch includes two sets of interleaved plates.

19. The vehicle driveline component of claim 18 wherein the vehicle driveline component includes a torque splitting mechanism adapted to transfer rotary power to first and second sets of vehicle wheels.

20. The vehicle driveline component of claim 19 wherein the torque splitting mechanism is sized to transfer a torque based on the threshold torque and less than the predetermined peak torque.
